(19) United States
(12) Patent Application Publication
(10) Pub. No.: US 2015/0227988 A1
(43) Pub. Date: Aug. 13, 2015

(54) EXPERT ENDORSEMENT VIA THIRD PARTY WEB CERTIFICATE

(71) Applicant: ROBERT VOZDECKY, NEW YORK, NY (US)

(72) Inventor: ROBERT VOZDECKY, NEW YORK, NY (US)

(21) Appl. No.: 14/178,440

(22) Filed: Feb. 12, 2014

(51) Int. Cl. G06Q 30/02

(52) U.S. Cl. CPC G06Q 30/0282

(57) ABSTRACT

An end-user visits a website. A web seal is first displayed on the web page. This web seal is issued by a third party which is an organization. The seal is represented by an expert in a specific field. The expert may come from the medical field (e.g. a doctor), the educational field (e.g. a teacher), the legal field (e.g. a lawyer), the sports field (e.g. a coach), the general field (e.g. a celebrity), the science field (e.g. a scientist), or another relevant field. When an end-user clicks on the web seal, a secondary browser window opens with a certificate that displays the expert's photo or video, credentials and endorsement. The certificate is served from the third-party server, so that the end-user sees the third-party domain name in the web browser's address bar. This validates authenticity of the certificate and the end-user is assured that the content of the web page is trustworthy and genuine.

### FIELD OF INVENTION

The present invention relates to computer technology. Specifically, the present invention relates to a method of providing online third-party endorsement and validation using a web seal and an expert's web certificate to establish credibility and trust between the end-user and the visited website.

### BACKGROUND OF THE INVENTION

The unprecedented popularity of the Internet has led to an explosion in Internet users, both consumers and e-commerce businesses. The ease of creating and accessing websites has resulted in considerable growth of information that will continue to grow exponentially. As consumers access businesses via the web the safety and authenticity of business websites becomes a concern.

The prior scenario can be problematic for the both end-users and e-commerce businesses. The end-user visiting a business online may find it difficult to believe the authenticity of the information provided by the website. At the same time, businesses also have limited means of convincing the end user that their information is genuine and their business is legitimate.

E-commerce has shown rapid growth. However, most of the time users are only presented with information created by the merchant and the user may not be convinced the information provided is credible and trustworthy. That is why many consumers prefer to purchase only from large, well-known e-commerce websites. As a result, lesser-known e-commerce websites suffer from lack of credibility and receive fewer sales. Therefore, if e-commerce businesses can provide easily verified third-party authentication to demonstrate their compliance with ethical business standards, end-users will have an easier experience performing due diligence, and lesser-known e-commerce businesses will benefit.

Consumers often research a product before purchasing by reading reviews. Because most reviews are not authenticated or confirmed, online reviews have considerable limitations, making it necessary for businesses to pursue other methods of reinforcing credibility and trustworthiness.

For the benefit of both the consumer and the e-commerce business, it is beneficial for businesses to establish authenticity and credibility using third-party confirmation. It is vital that an e-commerce business offers credible products and services and makes it simple for consumers to verify said credibility. Without authentication, end-users may be skeptical of the product or service in question. Furthermore, if an end-user trusts a fraudulent business without verifying its authenticity and ethical business practices, the user may become a victim of fraud.

Current search engines may direct an end user to the top-ranked businesses. Search engine rankings are often based on a combination of inbound links, social media activity, user ratings, and page views. Search engine results do not indicate the ethical standards of the business, nor do they demonstrate validity of the website content or performance of the business's products and services. Inbound links, user ratings, and social media activity can be manipulated or falsified by unethical businesses. It is possible for an unethical website to receive a top ranking in search results.

Therefore, demand exists for a method that establishes the credibility, trustworthiness and ethical standards of an e-commerce business and its products or services. Such a method would also validate website content and business practices in order to establish credibility and trust between the end-user and the e-commerce business.

### BRIEF SUMMARY OF THE INVENTION

The present invention demonstrates an effective method of presenting third-party endorsement and validation of e-commerce businesses. Specifically, the present invention utilizes a web seal and a web certificate to display an expert's statement of endorsement, photo (or video) and credentials, establishing credibility and trust between the end-user and the e-commerce business.

In one embodiment, the end-user visits a website. A web seal is first displayed on the web page. This web seal is issued by a third party. The third party 1 is represented by a human expert. The expert may originate from the medical field (e.g. a doctor, veterinarian, nurse, or pharmacist), the education field (e.g. a teacher), the legal field (e.g. a lawyer), the sports field (e.g. an athlete or a coach), or the science field (e.g. a scientist) among others. Or the expert may be a credible person likely to be recognized by the end-user such as an actor, celebrity, or politician among others.

In a preferred embodiment, when an end-user selects the web seal, a secondary browser window is opened, loading a certificate that displays an expert's photo (or video), credentials and endorsement. The described certificate is hosted on a third-party server, so that the end-user can view the third-party domain name in the web browser's address bar. This validates authenticity of the certificate. Thus, the end-user is assured that the website is trustworthy and legitimate.

An object of the invention is to provide a method where the third-party web certificate will provide endorsement of the second party's product, service or content from an expert in the field.

Another object of an invention is to provide a method where the web certificate will contain the expert's photo (or video), his or her credentials, and his or her endorsement of the product, service or content of the second party.

### BRIEF DESCRIPTION OF DRAWINGS

The accompanying drawings, which are incorporated in and constitute a part of this specification, exemplify the embodiments of the present invention and, together with the description, serve to explain and illustrate principles of the invention. The drawings illustrate major features of the exemplary embodiments in a diagrammatic manner. The drawings are not intended to depict every feature of actual embodiments nor relative dimensions of the depicted elements, and are not drawn to scale.

FIG. 1 is a block diagram of the method, in accordance with an aspect of the present invention.

FIG. 2 is a flowchart of a method of expert endorsement via a third-party web seal and certificate, in accordance with an aspect of the present invention.

### DETAILED DESCRIPTION OF THE INVENTION

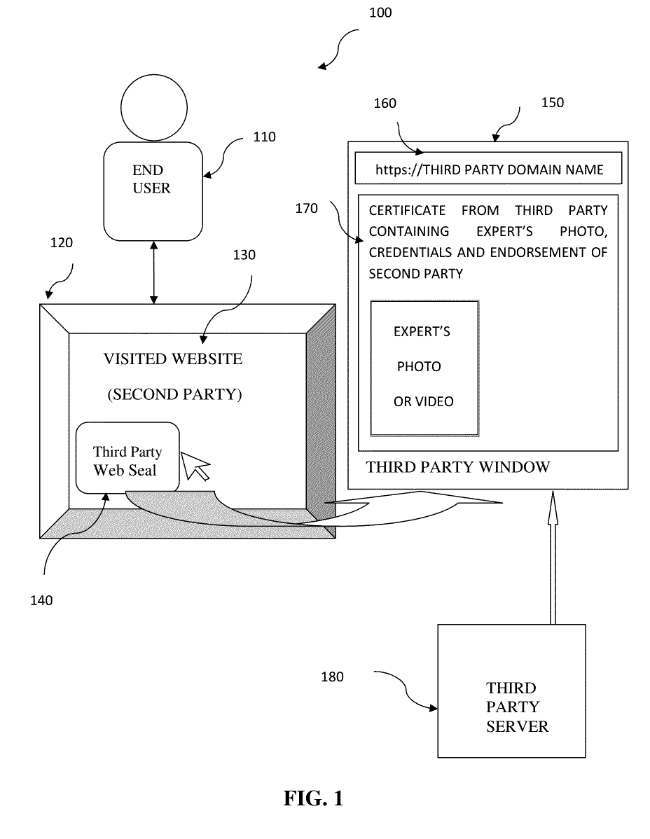

An embodiment of the invention will now be described in detail with reference to figures. FIG. 1 is a block diagram of a method 100, in accordance with an aspect of the present invention. The method 100 includes an end-user 110, hereinafter also referred as a first party, and a display device 120. The visited website 130, hereinafter also referred to as a second party, displays a web seal 140 issued by an organization, hereinafter referred to as a third party. A secondary window 150 opens when end user 110 clicks on the web seal 140. The address bar 160 of the secondary window 150 displays the third-party domain name as the certificate 170 is served from the third-party server 180. The secondary window 150 displays a certificate 170 from the third party, which contains the expert's photo (or video) and credentials and his or her endorsement information of visited website 130.

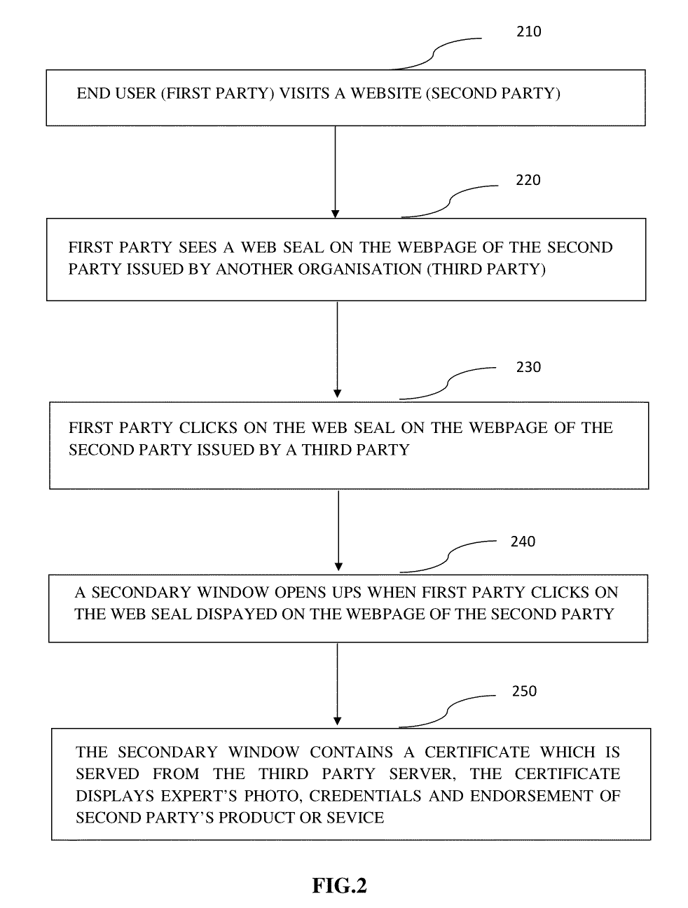

FIG. 2 is a flowchart detailing the preferred method 100 of the present invention. At step 210, a first party 110 visits a website 130 on a communication network site, such as an Internet website. At step 220, the first party 110 sees a web seal 140 on the web page of the second party 130, which is issued by a third party. At step 230, the first party 110 clicks on the web seal 140 on the web page of the second party 130. At step 240, secondary window 150 opens when the first party 110 clicks on the web seal 140. At step 250, the first party 110 views a certificate 170 issued by a third party. The certificate 170 displays the expert's photo (or video), credentials and endorsement of second-party product or service. The address bar 160 of the secondary browser window 150 shows the domain name of the third party as the certificate 170 is served from the third-party server 180.

The third party is an organization that issued the web seal 140 represented by an human expert in a specific field or other credible person. The expert may be from the medical field (e.g. doctor, veterinarian, nurse, or pharmacist), or any other field, such as education (e.g. a teacher), legal (e.g. a lawyer), sports (e.g. an athlete or a coach), general (e.g. an actor, celebrity, politician), science (e.g. a scientist), or another field relevant to the second party's product, service or website content. The secondary browser window 150 may also display descriptive and other information related to the expert, such as the expert's photograph or video, name, credentials, and other validation. The web certificate 170 promotes credibility for second party 130, as the first party 110 views details of the expert and can determine whether said expert is capable of endorsing the second party's product or service, which promotes credibility for the second party 130.

As the certificate 170 is served from the third party's server 180, the first party 110 views the third-party domain name in the web browser's address bar 160. This validates the authenticity of the certificate 170.

While this invention has been described by reference to a preferred embodiment, it should be understood that numerous changes could be made within the scope of the inventive concepts described. Accordingly, it is intended that the invention not be limited to the disclosed embodiment, but that it have its full scope permitted by the language of the following claims.

1. A method comprising:
visiting a second party by a first party;
displaying a web seal by said second party, said web seal being issued by a third party;
clicking on said web seal by said first party;
displaying of a secondary browser window with a certificate when said first party clicks on said web seal;
serving of said certificate being done from said third party's server;
appearing of third party's domain name in said secondary browser window's address bar;
characterized in that endorsing said second party's content by an expert in the field wherein said certificate contains expert's photo, video and credentials and endorsement information so that said first party sees the expert's detail information that establishes credibility for said second party.

2. The method of claim 1, wherein said first party is any website visitor.

3. The method of claim 1, wherein said second party is any visited website.

4. The method of claim 1, wherein said third party is an organization that issues said web seal and certificate.

5. The method of claim 1, wherein said expert is from medical field, educational field, legal field, sports field, general field or another relevant field.

6. The method of claim 1, wherein said endorsement information is about said second party's product, service or content.
